(19) United States
(12) Patent Application Publication
(10) Pub. No.: US 2022/0353087 A1
(43) Pub. Date: Nov. 3, 2022

(54) METHODS AND SYSTEMS FOR IMPLEMENTING PRIVACY-PRESERVING DARK POOLS

(71) Applicant: JPMorgan Chase Bank, N.A., New York, NY (US)

(72) Inventors: Gilad ASHAROV, Givaat Shmuel (IL); Tucker Richard BALCH, New York, NY (US); Antigoni Ourania POLYCHRONIADOU, New York, NY (US); Maria Manuela VELOSO, New York, NY (US)

(73) Assignee: JPMorgan Chase Bank, N.A., New York, NY (US)

(21) Appl. No.: 17/753,608

(22) PCT Filed: Sep. 16, 2019
(86) PCT No.: PCT/US2019/051300

§ 371 Date: Mar. 9, 2022

(30) Foreign Application Priority Data
Sep. 10, 2019 (GR) 20190100389

(51) Int. Cl. H04L 9/32; H04L 9/00; G06Q 40/04

(52) U.S. Cl. CPC H04L 9/3239; H04L 9/008; G06Q 40/04; H04L 2209/56; H04L 2209/42; H04L 2209/46

(57) ABSTRACT

Systems and methods for preserving privacy in dark pool trading environments are provided. The methods include receiving buy orders that include encrypted buy order information; receiving sell orders that include encrypted sell order information; determining whether at least one received buy order matches with at least one received sell order; and when there is a match, executing a transaction based on the match. The determination is made without revealing the encrypted information to an operator of the dark pool, thereby preserving the confidentiality of the information until the transaction is executed.

### CROSS-REFERENCE TO RELATED APPLICATION

This International Application claims priority of Greek Patent Application No. 20190100389 filed Sep. 10, 2019, the disclosure of which is expressly incorporated by reference herein in its entirety

### BACKGROUND

### 1. Field of the Disclosure

This technology generally relates to methods and systems for implementing privacy protections in a trading environment, and more particularly to methods and systems for implementing privacy protections in private forums for trading financial products.

### 2. Background Information

Public exchanges, such as the New York Stock Exchange (NYSE) or NASDAQ, act as auctioneers in a public double auction process. Potential buyers and sellers interact with the auctioneer, and submit their bids or asking prices. Buyers submit the maximal price they are willing to pay for the security, while sellers submit the minimal price they are willing to receive for selling the security. Both the seller and the buyer also submit the number of shares they are willing to trade. The auctioneer looks for matches between all orders it receives, and once matching orders are found, it executes the order.

All orders are submitted to the public exchange in the clear, which inevitably impact the market: a seller that wishes to sell a large amount of securities and submits such an order to the exchange will immediately move the price downwards and against himself, due to the sharp increase of the supply of that security. Similarly, a buyer that submits a bid for a large quantity of a particular stock will immediately move the price of the stock upwards and against himself.

In order to decrease such market impacts, traders use “dark pools”. A dark pool is a private forum for trading financial products. Buyers and sellers send private orders that are visible only to the operator of the dark pool, and the operator executes an order matching system, similarly as in a public exchange. Only when matching orders are found, the orders are executed and reported in the public exchange. Because the large orders are not visible to others, the risk of significant price moves is reduced.

Mistrust and conflicts of interest exist between the operator of a dark pool and its participants. The operator sees all order posted by all participants, including sensitive information such as the volume of the order and the bid or ask price. Therefore, there is a need to implement a mechanism for preserving the privacy within a dark pool by hiding the sensitive information from the operator of the dark pool.

### SUMMARY

The present disclosure, through one or more of its various aspects, embodiments, and/or specific features or sub-components, provides, inter alia, various systems, servers, devices, methods, media, programs, and platforms for implementing privacy-preserving dark pools. The various aspects, embodiments, features, and/or sub-components provide optimized processes of implementing privacy-preserving dark pools.

According to an aspect of the present disclosure, a method for preserving privacy in a trading environment is provided. The method is implemented by a processor on a computing device. The method includes: receiving, from each of a first plurality of users, a respective buy order to buy a respective security, each respective buy order including encrypted buy order information; receiving, from each of a second plurality of users, a respective sell order to sell a respective security, each respective sell order including encrypted sell order information; determining, by the processor, whether at least one received buy order matches with at least one received sell order; and when a determination is made that the at least one received buy order matches the at least one received sell order, executing a transaction based on the matching at least one received buy order and the matching at least one received sell order. The determining includes comparing the encrypted buy order information of each received buy order with the encrypted sell order information of each received sell order without decrypting the encrypted buy order information of each received buy order and without decrypting the encrypted sell order information of each received sell order. The execution of the transaction includes decrypting the encrypted buy order information of the matching at least one received buy order, decrypting the encrypted sell order information of the matching at least one received sell order, and disclosing the decrypted information to an operator of the computing device.

For each respective buy order, the encrypted buy information may include an encrypted security identifier, an encrypted number of shares, and an encrypted maximum offer price.

For each respective sell order, the encrypted sell order information may include an encrypted security identifier, an encrypted number of shares, and an encrypted minimum sell price.

The determining may include using a secure Multi-Party Computation (MPC) cryptographic protocol to implement a matching algorithm. Each respective buy order and each respective sell order may be transmitted in an encrypted way based on an instruction that relates to the MPC cryptographic protocol.

Alternatively, the determining may include using a fully homomorphic encryption (FHE) scheme to implement a matching algorithm, transmitting a result of the matching algorithm to each of the first and second pluralities of users, and receiving, from each user in response to the transmitting, decryption information that is usable for determining whether a match exists. Each respective buy order and each respective sell order may be transmitted in an encrypted way based on an instruction that relates to the FHE scheme.

Alternatively, the determining may include using a fully homomorphic encryption (FHE) scheme or any one of its variants, including but not limited to: threshold fully homomorphic encryption or multi-key homomorphic encryption, to implement a matching algorithm. The processor may operate on encrypted data to obtain encrypted information of whether or not a match is found, and if a match is found, then to also obtain encrypted information about the matching orders. In order to decrypt this encrypted information, the processor may transmit the encrypted information to the first and second pluralities of users, and receive, from each user in response to the transmitting, a partial decryption information that is usable to decrypt the evaluated information. Each respective buy order and each respective sell order may be transmitted in an encrypted way based on an instruction that relates to the FHE scheme.

According to yet another aspect of the present disclosure, a method for preserving privacy in a trading environment is provided. The method is implemented by a processor on a computing device. The method includes: receiving, from each of a plurality of users, a respective order that relates to a respective security, each respective order including encrypted order information; submitting a first order that relates to a first security, the first order including first order information; determining, by the processor, whether at least one received order matches with the submitted first order; and when a determination is made that the at least one received order matches the submitted first order, executing a transaction based on the matching at least one received order and the submitted first order. The determining includes comparing the encrypted buy order information of each received buy order with the encrypted sell order information of each received sell order without decrypting the encrypted buy order information of each received buy order and without decrypting the encrypted sell order information of each received sell order. The executing the transaction includes decrypting the encrypted buy order information of the matching at least one received buy order, decrypting the encrypted sell order information of the matching at least one received sell order, and disclosing the decrypted information to an operator of the computing device.

For each received order, the encrypted order information may include an encrypted security identifier, an encrypted buy/sell indicator that indicates one of a buy order and a sell order, an encrypted number of shares, and an encrypted order price. Additional fields may be included.

The first order information may include a first security identifier, a first buy/sell indicator that indicates one of a buy order and a sell order, a first number of shares, and a first order price. When the first buy/sell indicator indicates a buy order, the determining may include determining whether the encrypted order information of at least one received order includes an encrypted security identifier that matches the first security identifier, an encrypted buy/sell indicator that indicates a sell order, and an encrypted order price that is less than or equal to the first order price. When the first buy/sell indicator indicates a sell order, the determining may include determining whether the encrypted order information of at least one received order includes an encrypted security identifier that matches the first security identifier, an encrypted buy/sell indicator that indicates a buy order, and an encrypted order price that is greater than or equal to the first order price.

The determining may include using a secure Multi-Party Computation (MPC) cryptographic protocol to implement a matching algorithm. Each respective buy order and each respective sell order may be transmitted in an encrypted way based on an instruction that relates to the MPC cryptographic protocol.

Alternatively, the determining may include using a fully homomorphic encryption (FHE) scheme to implement a matching algorithm, transmitting a result of the matching algorithm to each of the first and second pluralities of users, and receiving, from each user in response to the transmitting, decryption information that is usable for determining whether a match exists. Each respective buy order and each respective sell order may be transmitted in an encrypted way based on an instruction that relates to the FHE scheme.

According to still another aspect of the present disclosure, a system for preserving privacy in a trading environment is provided. The system includes a processor, a memory, and a communication interface coupled to each of the processor and the memory. The processor is configured to: receive, via the communication interface, from each of a first plurality of users, a respective buy order to buy a respective security, each respective buy order including encrypted buy order information; receive, via the communication interface, from each of a second plurality of users, a respective sell order to sell a respective security, each respective sell order including encrypted sell order information; determine whether at least one received buy order matches with at least one received sell order; and when a determination is made that the at least one received buy order matches the at least one received sell order, execute a transaction based on the matching at least one received buy order and the matching at least one received sell order. The processor is further configured to make the determination by comparing the encrypted buy order information of each received buy order with the encrypted sell order information of each received sell order without decrypting the encrypted buy order information of each received buy order and without decrypting the encrypted sell order information of each received sell order. When the transaction is executed, the processor is further configured to decrypt the encrypted buy order information of the matching at least one received buy order, decrypt the encrypted sell order information of the matching at least one received sell order, and disclose the decrypted information to an operator of the system.

For each respective buy order, the encrypted buy information may include an encrypted security identifier, an encrypted number of shares, and an encrypted maximum offer price.

For each respective sell order, the encrypted sell offer information may include an encrypted security identifier, an encrypted number of shares, and an encrypted minimum sell price.

The processor may be further configured to make the determination by using a secure Multi-Party Computation (MPC) cryptographic protocol to implement a matching algorithm. Each respective buy order and each respective sell order may be transmitted in an encrypted way based on an instruction that relates to the MPC cryptographic protocol.

Alternatively, the processor may be further configured to make the determination by using a fully homomorphic encryption (FHE) scheme to implement a matching algorithm, transmitting a result of the matching algorithm to each of the first and second pluralities of users, and receiving, from each user in response to the transmitting, decryption information that is usable for determining whether a match exists. Each respective buy order and each respective sell order may be transmitted in an encrypted way based on an instruction that relates to the FHE scheme.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for preserving privacy in a dark pool trading environment.

FIG. 4 is a flowchart of an exemplary method for preserving privacy in a dark pool trading environment.

FIG. 5 illustrates a structure of a dark pool with a single operator, according to an exemplary embodiment.

FIG. 6 illustrates a structure of a dark pool with multiple operators, according to an exemplary embodiment.

FIG. 7 illustrates a structure of a cross dark pools collaboration, according to an exemplary embodiment.

FIG. 8 illustrates a structure of a dark pool with no operator, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

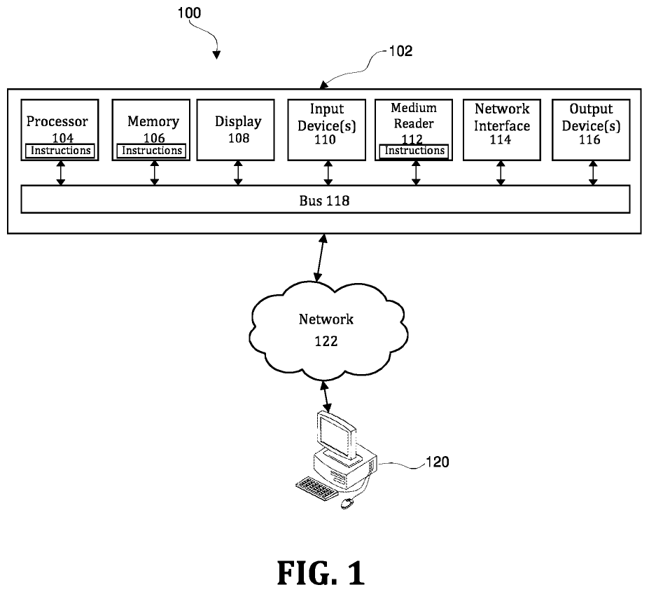

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a client-server user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized processes for implementing privacy protections in private forums for trading financial products.

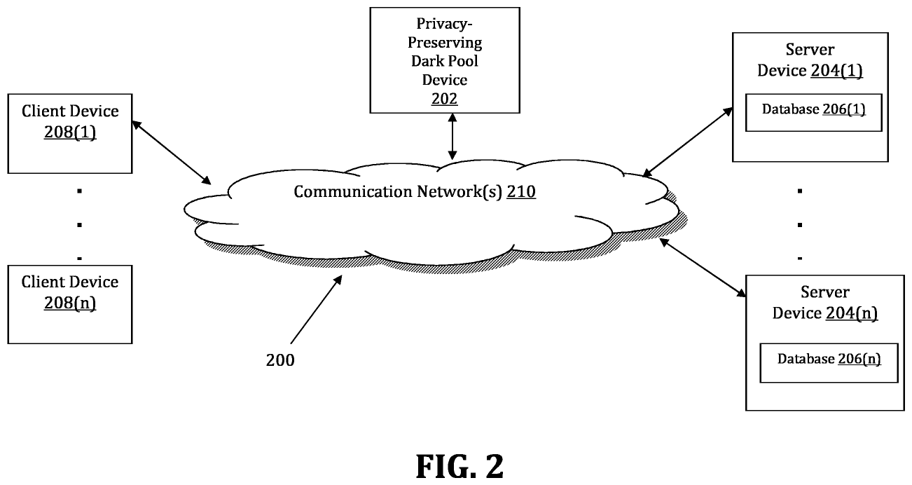

Referring to FIG. 2, a schematic of an exemplary network environment 200 for implementing a method for implementing privacy protections in private forums for trading financial products is illustrated. In an exemplary embodiment, the method is executable on any networked computer platform, such as, for example, a wireless mobile communication device, i.e., a smart phone.

The method for providing privacy protections in private forums for trading financial products may be implemented by a Privacy-Preserving Dark Pool (PPDP) device 202. The PPDP device 202 may be the same or similar to the computer system 102 as described with respect to FIG. 1. The PPDP device 202 may store one or more applications that can include executable instructions that, when executed by the PPDP device 202, cause the PPDP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PPDP device 202 itself, may be located in virtual server(s) running in a cloud-based computing environment rather than being tied to one or more specific physical network computing devices. Also, the application(s) may be running in one or more virtual machines (VMs) executing on the PPDP device 202. Additionally, in one or more embodiments of this technology, virtual machine(s) running on the PPDP device 202 may be managed or supervised by a hypervisor.

In the network environment 200 of FIG. 2, the PPDP device 202 is coupled to a plurality of server devices 204(1)-204(n) that hosts a plurality of databases 206(1)-206(n), and also to a plurality of client devices 208(1)-208(n) via communication network(s) 210. A communication interface of the PPDP device 202, such as the network interface 114 of the computer system 102 of FIG. 1, operatively couples and communicates between the PPDP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PPDP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PPDP devices that efficiently implement privacy protections in private forums for trading financial products.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PPDP device 202 may be a standalone device or integrated with one or more other devices or apparatuses, such as one or more of the server devices 204(1)-204(n), for example. In one particular example, the PPDP device 202 may include or be hosted by one of the server devices 204(1)-204(n), and other arrangements are also possible. Moreover, one or more of the devices of the PPDP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PPDP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store public exchange data, order book data, and any other data that relates to implementing privacy protections in private trading forums.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a primary/secondary approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can facilitate the execution of a web application. Accordingly, the client devices 208(1)-208(n) may be mobile computing devices, desktop computing devices, laptop computing devices, tablet computing devices, virtual machines (including cloud-based computers), and/or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PPDP device 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the PPDP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PPDP device 202, the server devices 204(1)-204(n), or the client devices 208(1)-208(n), for example, may be configured to operate as virtual instances on the same physical machine. In other words, one or more of the PPDP device 202, the server devices 204(1)-204(n), or the client devices 208(1)-208(n) may operate on the same physical device rather than as separate devices communicating through communication network(s) 210. Additionally, there may be more or fewer PPDP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

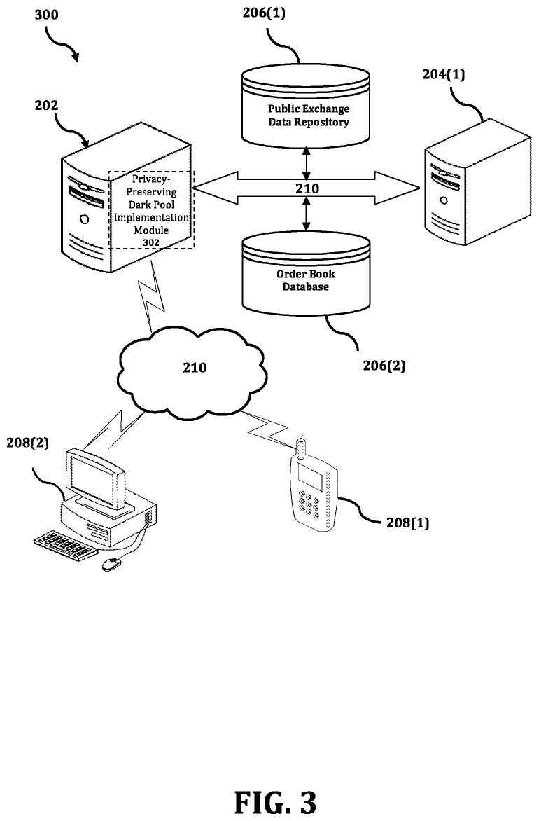

The PPDP device 202 is described and shown in FIG. 3 as including a privacy-preserving dark pool implementation module 302, although it may include other modules, databases, or applications, for example. As will be described below, the privacy-preserving dark pool implementation module 302 is configured to process large numbers of encrypted buy orders and sell orders in order to facilitate trade executions within the private trading forum environment in an automated, efficient, scalable, and reliable manner.

An exemplary process 300 for implementing privacy protections in private forums for trading financial products by utilizing the network environment of FIG. 2 is shown as being executed in FIG. 3. Specifically, a first client device 208(1) and a second client device 208(2) are illustrated as being in communication with PPDP device 202. In this regard, the first client device 208(1) and the second client device 208(2) may be “clients” of the PPDP device 202 and are described herein as such. Nevertheless, it is to be known and understood that the first client device 208(1) and/or the second client device 208(2) need not necessarily be “clients” of the PPDP device 202, or any entity described in association therewith herein. Any additional or alternative relationship may exist between either or both of the first client device 208(1) and the second client device 208(2) and the PPDP device 202, or no relationship may exist.

Further, PPDP device 202 is illustrated as being able to access a public exchange data repository 206(1) and an order book database 206(2). The privacy-preserving dark pool implementation module 302 may be configured to access these databases for implementing a process for preserving privacy protections in private forums for trading financial products.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PPDP device 202 via broadband or cellular communication. Of course, these embodiments are merely exemplary and are not limiting or exhaustive.

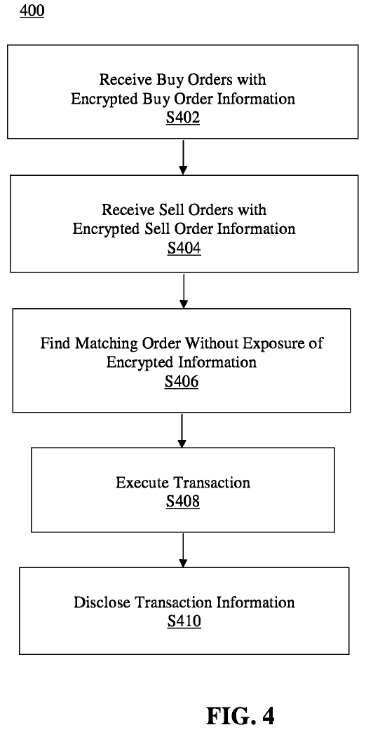

Upon being started, the privacy-preserving dark pool implementation module 302 executes a process for implementing privacy protections in private forums for trading financial products. An exemplary process for implementing privacy protections in private forums for trading financial products is generally indicated at flowchart 400 in FIG. 4.

In the process 400 of FIG. 4, at step 5402, the privacy-preserving dark pool implementation module 302 receives buy orders that include encrypted buy order information. In an exemplary embodiment, each buy order includes an encrypted security identifier that identifies the security to which the order pertains, an encrypted buy/sell indicator that indicates that the order is a buy order (as opposed to a sell order), an encrypted number of shares, and an encrypted maximum offer price. The security identifier may be a symbol that identifies a corporate entity.

At step S404, the privacy-preserving dark pool implementation module 302 receives sell orders that include encrypted sell order information. In an exemplary embodiment, each sell order includes an encrypted security identifier that identifies the security to which the order pertains, an encrypted buy/sell indicator that indicates that the order is a sell order (as opposed to a buy order), an encrypted number of shares, and an encrypted minimum sell price. The security identifier may be a symbol that identifies a corporate entity.

In an exemplary embodiment, steps S402 and S404 may be performed in any order, i.e., these steps may be executed in parallel and/or simultaneously. Further, in an exemplary embodiment, there may be communication between an operator and a market participant in advance of the reception of buy orders and sell orders that include encrypted information in steps S402 and S404. In this aspect, the encrypted orders may be jointly generated by the parties. For example, the operator may provide a public key to be used by the market participant in generating the encrypted order, and the market participant may then use the public key to generate the order prior to transmitting the encrypted order to the operator.

At step S406, the privacy-preserving dark pool implementation module 302 determines whether any of the received buy orders matches with any of the received sell orders without exposure of any of the encrypted information. In particular, the encrypted information remains undisclosed to the operator of the dark pool, thereby preserving the privacy of the dark pool participants. In an exemplary embodiment, the matching procedure may be performed by using a secure Multi-Party Computation (MPC) cryptographic protocol or a fully homomorphic encryption (FHE) scheme.

In an exemplary embodiment, when the FHE protocol is used, each respective buy order and each respective sell order is transmitted in an encrypted way based on an instruction that relates to the FHE protocol. Further, the determination regarding the match may include using the FHE protocol to implement a matching algorithm by which the encrypted information remains fully encrypted; transmitting a result of the matching algorithm to each pool participant; and receiving, from each pool participant, decryption information that is usable for determining whether a match has been found.

At step S408, when matching orders are found, the privacy-preserving dark pool implementation module 302 executes a transaction based on the match. Then, at step S410, the transaction information is disclosed to the operator of the dark pool, and the operator executes the trades in the public exchange.

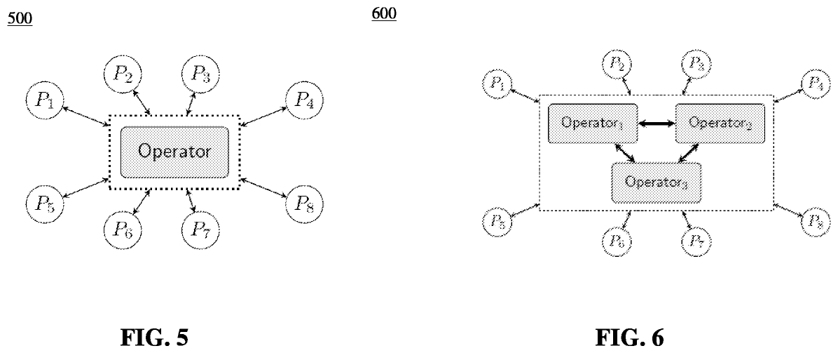

Referring to FIGS. 5-8, a dark pool may be structured in several different ways. FIG. 5 illustrates a structure 500 of a dark pool with a single operator, according to an exemplary embodiment.

As illustrated in FIG. 5, a set of parties P₁, P₂, P₃, P₄, P₅, P₆, P₇, P₈ may wish to execute trades without exposing their respective buy and sell demands. In particular, the parties do not wish to reveal which shares they are willing to buy or sell, the amount, the ask or bid price, and not even the type of the order—i.e., whether they are willing to buy or to sell. The parties do not want to reveal this information, not even to the operator of the dark pool.

A privacy preserving dark pool is a system where parties send their buy and sell orders to an operator in an encrypted way using special encryption schemes which enable the operator to process the encrypted data in order to determine whether there is a match or not. When matching orders are found, the participants are notified and the matching orders are revealed to the public. The operator can then execute the matching orders. Since orders remain private to the operator, privacy-preserving dark pools have the potential to further reduce market impacts compared to standard dark pools, as well as to significantly reduce the tension between the participants of the dark pool and its operator.

FIG. 6 illustrates a structure 600 of a dark pool with multiple operators, according to an exemplary embodiment. In this scenario, the multiple operators may include, for example, any one or more of a bank, a financial institution, or any other institute, and the participants never reveal their private orders to any one of the operators. The operators together maintain one virtual order book, in which the information is kept secret by encryption methods. Each participant “secret shares” its order to the corresponding operator, such that no operator ever learns the order. The operators jointly run the matching algorithms on shared orders. For the case where matching orders are found, the orders are revealed to the operators and are executed in the public exchange. This scenario might be interpreted as a regular dark pool in which the operator is split into different operators, each of which is being controlled by a different institution, and which communicate with each other using MPC. In an additional scenario, the dark pool itself is privacy-preserving, and then split into different operators, each of which is being controlled by a different institution.

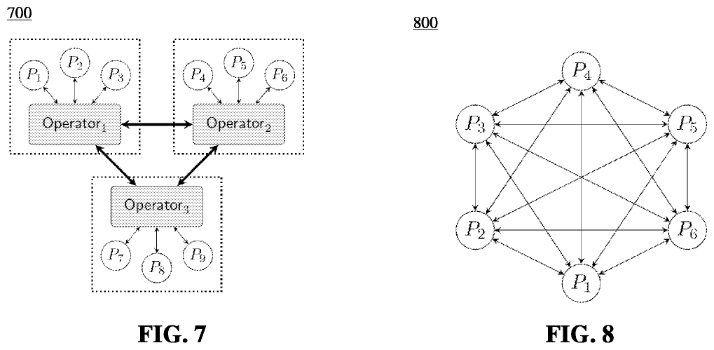

FIG. 7 illustrates a structure 700 of a cross dark pools collaboration, according to an exemplary embodiment. In this mechanism, each dark pool operates similarly as a standard dark pool. Each dark pool has an operator and its own users/clients (participants), and within each dark pool, the order information may be known to the operator. In the cross dark pools collaboration, several operators of independent dark pools can pool their private order books together in order to find matches across the different dark pools. No operator is required to reveal its private order book to its counterparts. In particular, the operators exchange their order books in an encrypted form. The operators jointly run the matching algorithm on their encrypted order book data, and may significantly increase the potential number of matches. When matching orders are found, the orders are revealed to the relevant two operators to which the matched orders were submitted. These parties can then execute the matched orders in the public exchange. Throughout the process, unmatched orders remain secret. The number of collaborating operators may be two or more. In an additional scenario, each dark pool operator, controlled by a different institution, does not act as a standard dark pool, but instead as a privacy-preserving dark pool with its own users/clients (participants). In this scenario, each operator receives the orders from its own clients in an encrypted way. Then the operators pool their encrypted order books together in order to find matches across the different clients. In particular, each client speaks only to one operator (and provides the order encrypted to that operator), then the operators communicate with each other to find out whether there is a match or not.

FIG. 8 illustrates a structure 800 of a dark pool with no operator, according to an exemplary embodiment. In this scenario, there is no operator, and parties communicate with each other directly and wish to execute trades without exposing their orders. Parties exchange their buy and sell orders in an encrypted way, and jointly compute whether there is a match or not, such that no information about the orders is revealed unless there is a match.

In an exemplary embodiment, a dark pool consists of n participants P₁, P₂, P₃, . . . Pₙ, together with an operator O. The operator O maintains a state Order Book which is initially empty. At every point of time, each participant P, may issue a new order to the operator O using a private and authenticated channel. Each order has one of the following two forms:

(Buy, symb, num, maxPrice): where symb is the symbol of the shares to buy, num is the number of securities to buy and maxPrice is the maximum price that the buyer agrees to pay per share.

(Sell, symb, num, minPrice): where symb and num are as above, and minPrice is the minimum price for which the seller agrees to sell each share.

With each issuing of a new order, the operator O attempts to resolve the order, by matching the order with previous orders stored in the Order Book that have not yet been resolved. The complexity of this matching algorithm arises due to the fact that each order might ask for a different amount of shares. Thus, there may be partial matches, i.e., a new order can be satisfied by a combination of few previous orders, in which their total amount is the volume of the new order. If the new order cannot be resolved, it will be added to the Order Book together with a time stamp and an indicator of the party that initiated the order.

In an exemplary embodiment, an operator O may attempt to resolve a new Buy order as follows (noting that resolving a new Sell order can be performed in an equivalent manner): Upon receiving an order (Buy; XYZ; nB; b) with symbol XYZ of nB shares and price b, the operator O executes the following code:

Resolve (Buy; XYZ; nB; b):

1. Iterate over Order Book and look for an order (Sell; symb; nS; s) of nS shares and price s for which the following conditions hold: (1) symb=XYZ; (2) s<=b; (3) Among all orders that satisfy the above conditions, choose the one for which s is minimal, denote this minimal s by v; (4) Break all other ties according to the time orders were issued, preferring older orders over new ones (noting that there may be other ways to break ties, such as, for example, randomly; or partially fulfilling all matching orders). If no matching order was found, then add (Buy; XYZ; nB; b) to Order Book and exit.

2. Let n=min {nB, nS} represent the number of shares to be traded.

3. Execute (Buy; XYZ; n; v) and (Sell; XYZ; n; v).

4. If n=nB then the order (Buy; XYZ; nB; b) is completely resolved. Exit the procedure.

5. If n=nS, then the order (Sell; XYZ; nS; s) is completely resolved. Remove it from the Order Book, and repeat the process for (Buy; XYZ; nB)-n,b).

In an exemplary embodiment, a dark pool may allow more expressive types of orders. For instance, a participant might also request a minimal number x of shares to be executed in a partial match. In this aspect, if a potential match has number of shares n<x, then this is not considered as a match, because x is a minimum. An order may also include other fields, such as tiers. In an exemplary embodiment, additional conditions may be applied.

In an exemplary embodiment, applicable regulations that are enforceable by the United States Securities and Exchange Commission (SEC) must be satisfied when matching orders. For example, one SEC regulation requires that the two prices are within the national best bid and offer (NBBO). When the operator finds two matching orders, it checks that the two prices are within the national spread, and only if that condition applies it is allowed to execute the matches. When the NBBO price is changed, the operator can review its order book and look for potential matches that could have not been executed previously due to the NBBO price.

In an exemplary embodiment, the matching function may be performed by using a secure Multi-Party Computation (MPC) protocol. An MPC protocol allows a set of mutually distrustful parties to compute a function jointly over their inputs while maintaining the privacy of the inputs and ensuring the correctness of the outputs. Assuming the existence of some external trusted party, a trust-based solution can be given where the trusted party simply receives inputs from all the parties, computes the function and returns the result. Secure multiparty computation effectively eliminates the need for such an external trusted party, and has been demonstrated to be useful in a wide range of applications, such as, for example, replacement of auctioneers in clearing price auctions.

In an exemplary embodiment, the security of the protocol should be preserved even in the presence of some adversarial entity that corrupts some of the participating parties, combines their transcripts and coordinates their behaviors. For example, referring to FIG. 7, MPC may be used for cross dark pools collaboration, where the participants in the computation are several leading banks. Privacy of orders provided by the honest banks should be preserved even if some corrupted banks collaborate and pool the messages they received, or even deviate from the protocol specifications. Several different types of adversaries have been studied, where the complexity and the efficiency of the protocols depend on the level of security:

A semi-honest adversary (also known as “honest-but-curious” or “passive”), follows the protocol specification but may attempt to learn secret information about the private information of the honest parties from the messages it receives. The most efficient protocols can be constructed assuming that the adversary is semi-honest.

A malicious adversary (also known as “active”) may, in addition, deviate from the protocol specification and follow any arbitrary behavior. This is the strongest level of security possible, and protocols that achieve these level of security are often much slower than protocols that are secure in the presence of a semi-honest adversary. Such protocols usually work by adding many checks throughout the protocol execution that parties follow the protocol as specified.

A covert adversary provides an intermediate level of security, in which the adversary can effectively cheat; however, the protocol guarantees that any cheating attempt can be detected with some predetermined probability 0<p<=1. This value can also be interpreted as a “deterrent factor”. If the protocol also provides public verifiability, then in case a cheating attempt is detected, the honest parties can also publish the “transcript” of the protocol and the cheating attempt can be publicly verified. In this aspect, at the intuitive level, the honest parties can sue the corrupted parties and prove that a cheat had happened. These protocols are more efficient than a fully maliciously secure protocol, yet, some corruption might still occur. However, the rationale is that parties cannot afford the embarrassment, loss of reputation, and the legal consequences associated with being caught cheating, and therefore, these will act as a deterrent to parties and effectively prevent any cheating attempt.

In an exemplary embodiment, an important technique for secure computation is t-out-of-n Shamir's secret sharing. Such a scheme enables a dealer to split a secret into n shares while any subset of t shares does not give any information about the secret, while pooling t+1 shares completely reveal it. This technique enables parties to release private information to other parties while guaranteeing that even if t parties misbehave, they can still do not learn anything about the secret. The value t is called the privacy threshold of the scheme. More specifically, a secret-sharing scheme consists of two algorithms: the first algorithm, called the sharing algorithm (i.e., “Share”), takes as input the secret s and the parameters t and n, and outputs n shares. The second algorithm, called the recovery algorithm (i.e., “Recover”), takes as input t+1 shares and outputs a value s. It is required that the reconstruction of shares generated from a value s produces the same value s. The security requirement is that no subset of t parties is able to learn any information about the secret from their shares. Many MPC protocols follow the same typical gate-by-gate design paradigm: After agreeing on the function f to be computed, the parties agree on a (binary or arithmetic) circuit C that computes the function f. Initially all inputs are secret-shared among the parties (i.e., each party secret shares the values of the input wires associated with his/her input). Then, for each gate in the circuit, where both its inputs have been secret-shared, a sub-protocol that produces the output of the gate in a secret-shared form is executed. Finally, when the parties obtain shares of the values on the output wires, they simply reconstruct these shares to reveal the final outputs. This paradigm allows them to learn only the output of the computation and nothing else.

In addition to serving as a building block for building secure computation protocols, secret sharing may also be used when defining the input-output behavior of the functions that the parties are computing. For example, a possible implementation may apply the following procedure: Each participant first secret shares its private order using the algorithm Share and gives each operator a share of its secret order. No operator by itself has sufficient information to recover the order, and even if up to t operators collaborate together they cannot recover the order. Nevertheless, since the order is fully determined by the shares that the operators hold, a function may be defined that fully determines whether the order has another (secret) matching order, or not. For the case where a match is found, the matched orders are revealed by calling the Recover algorithm The algorithms Share and Recover may be instantiated by using any secret sharing scheme, such as Shamir's secret sharing, and/or any other suitable variant.

In an exemplary embodiment, a different approach for constructing secure protocols relies on fully homomorphic encryption (FHE). An FHE scheme facilitates a performance of arbitrary computations on encrypted data without decrypting it. In a nutshell, the data owner can encrypt its message m using its own key to receive some ciphertext c and then then send the encrypted message to an external party. The external party can then compute any function f on the ciphertext, which will result in a fresh ciphertext c0 that corresponds to f(m). The data owner can then decrypt c0 to obtain f(m).

In an exemplary embodiment, FHE solves the problem of secure computation between two parties, Alice and Bob: Alice encrypts her input and sends it to Bob, who can homomorphically evaluate the function on Alice's encrypted input and its own input, sending only the resulting ciphertext back to Alice, who can decrypt. Generalizing this template to the multiparty computation setting requires a variant of FHE called multi-key fully-homomorphic encryption (MFHE). This encryption scheme consists of the following algorithms:

Encryption. Each party generates a public/secret key-pair for the MFHE, encrypts its input under its individual public key, and broadcasts the public key and ciphertext.

Partial Decryption. Each party separately evaluates the function on the encrypted inputs, then uses its secret key to compute a decryption share of the resulting evaluated ciphertext and broadcasts that share to everyone.

Decryption. Once all the decryption shares are received, each party can combine them to obtain the function value, which is the output of the protocol.

In an exemplary embodiment, a variant of fully-homomorphic encryption is threshold fully-homomorphic encryption (TFHE). This variant consists of the following algorithms:

Key Generation. A public/secret key-pair for the TFHE is generated where each party receives the public key and a share of the secret key.

Encryption. Each party encrypts its input under the public key, and broadcasts the ciphertext.

Partial Decryption. Each party separately evaluates the function on the encrypted inputs, then uses its share of the secret key to compute a decryption share of the resulting evaluated ciphertext and broadcasts that share to everyone.

Decryption. Once all the decryption shares are received, each party can combine them to obtain the function value, which is the output of the protocol.

In an exemplary embodiment, referring to FIG. 6, a privacy-preserving dark pool with multiple operators structure may be implemented by using MFHE as follows: Each party calls the Encryption algorithm to encrypt his/her order and sends the ciphertext to the operator. Next, the operator runs the matching algorithm on the ciphertexts to produce a final ciphertext with the output (i.e. whether there is a match or not). Then, the operator sends the final ciphertext to the parties who run the decryption protocol to obtain the output and learn whether there is a match or not.

Referring to FIG. 7, in an exemplary embodiment, a cross dark pools collaboration structure may be implemented using a secure computation protocol. In this example, there is a clear definition of who are the participating parties, their inputs, and the functions that they are computing. In addition, the structure is defined based on the assumption that there is an external trusted party which all the operators can send their commands and requests. Using MPC techniques, this trusted party will be emulated by a secure protocol between the operators.

In this example, the functionality that the parties are computing is reactive. In this aspect, the external trusted party maintains a secret state, and the computation occurs in stages. At each invocation, the parties provide inputs to the trusted party, receives some outputs, and the trusted party updates its internal secret state

In an exemplary embodiment, a predicate Match between two orders o and o′ is defined. Each order has the format of (op; symb; num; price), where op={Buy or Sell} (i.e., op indicates whether the order is a buy order or a sell order), symb is the security to buy or sell, num is the number of shares to buy or sell, and price is the maximum price that the buyer agrees to pay per share, or the minimum price that the seller agrees to pay per share.

$$Definition 3.1 ( The predicate Match ) . For two orders ( o , {o}^{′} ) where o = ( op , symb , num , price ) and {o}^{′} = ( {op}^{′} , {symb}^{′} , {num}^{′} , {price}^{′} ) , and NBBO ' s range R = [ {nbbo}_{1} , {nbbo}_{2} ] it holds that Match ( o , {o}^{′} , R ) = 1 iff all following conditions hold :$$

$$1. op \neq {op}^{′} ,$$

$$2. symb = {symb}^{′} ,$$

$$3. price , {price}^{′} are in the range R ,$$

$$4. Ask price is always no bigger than bid price , that is$$

$$\{ \begin{matrix}{price}^{′} \leq price & if op = Buy and {op}^{′} = Sell \\ price \leq {price}^{′} & if op = Sell and {op}^{′} = Buy\end{matrix} ,$$

As described above, some orders might require additional attributes. For example, a trader might agree to accept a partial match only if the number of shares traded is greater than some value.

In an exemplary embodiment, Functionality 3.2 as defined below describes the input-output behavior of each command, as well as what each party (operator) provides and how to maintain the secret state. In an exemplary embodiment, secure computation protocols are used for realizing Functionality 3.2. In an exemplary embodiment, the following conditions are applicable to Functionality 3.2:

The secret state is maintained by secret sharing among the operators.

When an operator issues a command Resolve with respect to an order o_{new}, all operators are notified that a command Resolve was sent. Nevertheless, the order itself o_{new}, is a private input, and is being protected by the protocol.

The identity of the operator submitting the order is revealed to the other operators. As a result, the volume of the order book of each operator is revealed to others. Parties have the freedom to decide which orders to send to the collaborative dark pools, as well as when to submit that orders. The operators may then decide to work in a “real-time” fashion, such that whenever an order is received and cannot be matched within the individual dark pool, the corresponding operator will send the order to the virtual joint dark pool. Alternatively, the operators may decide to work jointly only at some particular agreed time, such as, for example, “the end of the day”.

Functionality 3.2: The Reactive Functionality F_{CrossDarkPools}

```
Participating parties: The participating parties are the operators of the individual dark
pools: [symbol]    ₁, . . . , [symbol]    ₘ. The functionality also interacts with the NBBO server and the public
exchange.
Secret state: The functionality maintains an internal state consisting of two objetcs --- OrderBook
and Matches. Moreover, it receives from the NBBO a range R = [nbbo₁, nbbo₂].
Supported commands: The functionality receives commands from its participants, and runs
the following code for executing the command. Any other command not included in the following
will be ignored.
  • Command InitOrderBook( ): Upon receiving the command from all operators [symbol]    ₁, . . . , [symbol]    ₘ:
    simply set OrderBook:=∅. Moreover, query NBBO for the current range R = [nbbo1, nbbo2],
    and store it in the secret state.
  • Command ExecuteMatches( ): Upon receiving the command from all operators, the
    functionality executes all matched orders in Matches in the public exchange, and sets
    Matches:=∅.
  • Command ResolveOrder(o_{new}): Upon receiving an order o_{new} = (op, symb, num, price)
    from some operator [symbol]    ₁, send all operators [symbol]    ₁, . . . , [symbol]    ₘ the message “Order Received”.
    Then, proceed as follows:
      1. Iterate over OrderBook and look for an order o_{book} = (op′, symb′, num′, price′) for
        which Match(o_{new}, o_{book}, R) = 1 (see Definition 3.1). Break ties by preferring an order
        for which |price - price′| is maximal; Break all other ties according to the relative
        order in OrderBook, preferring orders at the top of the book (i.e., older).
      2. If no o_{book} was found, then send all operators the message “Match Not Found”.
        Append o_{new} to the end of OrderBook, including some reference data on the party
        that issued this order [symbol]    ₁. Halt and wait for further commands.
      3. If a matching order o_{book} was found, let k be its index in OrderBook, and let Oₖ
        be the operator that initiated that order. Send all operators the message “Matched
        Order Found (j)”.
      4. Let n = min{num, num′}. Add to Matches the two orders (op, n, price′) and (op′, n,
      price′).
        Send to Oᵢ and Oₖ the message “Matched(op, n, price′)”, together with the associated
        reference data (e.g., time when the order was initially received).
      5. If n = num′ then o_{book} is completely resolved. Output to the operators the mes-
        sage “Removing from order book (j)”, remove o_{book} from OrderBook, and return
        to Step 1 with d_{new} = (op, symb, num - n, price).
      6. If n = num the o_{new} is completely resolved. Output “Resolved” to operators.
  • Command NBBORangeChanged(R′): Whenever the NBBO sends this command, output
    to all operators the message “NBBO Range Changed (R′)”. Moreover, update the internal
    state R = R′ and proceed as follows:
      1. Copy the entire book OrderBook′ = OrderBook = (oₗ, . . . , oₖ), and call com-
        mand InitOrderBook( ).
      2. For i = l, . . . , k, run ResolveOrder(oᵢ).
```

The stateful functionality (Functionality 3.2) may be implemented as a composition of several protocols for non-reactive functions, as follows:

The common implicit secret state of the operators is the list OrderBook. At every state of the protocol, there will be an invariant that this list is shared via a secret sharing scheme between the operators. In particular, the order book OrderBook is shared among the m operators, while each operator receives the share OrderBook_i.

When a client wishes to submit an order (in the clear) to a trusted operator, referred to herein as Operator O_j, the operator secret shares of each one of the attributes of the order to obtain shares s_1 , . . . , s_m. For example, it sends to the Operator O_i the share s_i.

In order to resolve a new order, the operators will run a secure computation protocol for realizing the function “ResolveOrder”, where the input of each operator is its respective share of OrderBook_i and its respective share of the new order—i.e., s_i.

The function that the parties compute first reconstructs the OrderBook from all shares OrdeerBook_i, and reconstructs the new order from all shares s_i. After running the function ResolveOrder, the functionality also re-secret shares the OrderBook and sends to each operator O_i a new share OrderBook_i′.

The implementation of the protocol can be effected by using any generic protocol for secure computation, such as [GMW87, BGW88, RB89, BMR90, SPDZ12], etc., and involves interaction between the operators.

Functionality 4.1: The Reactive Functionality F_{PPDF}

Participating parties: The participating parties are the participants (clients) Pₗ, . . . , Pₙ and
the operator [symbol] . The functionality also interacts with the NBBO server and the public exchange.
Secret state: Same as in Functionality 3.2.
Supported commands: The functionality supports the same commands as Functionality 3.2
with the following modifications: (1) All notifications and output of the functionality is given
solely to the operator; (2) Only the operator can issue the commands InitOrderBook and
ExecuteMatches. (3) Every participant Pₗ can send ResolveOrder.

A possible protocol for realizing this functionality (Functionality 4.1) will look as follows:

Setup: The parties run the KeyGen function of a TFHE scheme.

When a party wishes to submit an order, the party encrypts its attributes (op,symb,num,price), and then sends the encrypted information to the operator.

The operator can evaluate the new order and all previously non-resolved orders exactly as in “ResolveOrder” function, where the “OrderBook” is a list of encrypted orders, and the new order is an encrypted order. In order to perform this evaluation, the operator runs the “Eval” function of the TFHE scheme.

When resolving the order, the operator runs the Dec protocol of the TFHE scheme to decrypt the following information:

1) The operator computes (using TFHE.Eval) a ciphertext that indicates whether a matching encrypted order was found in the OrderBook. Moreover, it computes (using TFHE.Eval) a ciphertext to an index j of some order in the OrderBook which is best matched to the new order (if no order is found, this index j will not be considered later). Note that this includes also checking that the two prices are within the NBBO range. It runs the TFHE.decrypt to decrypt the ciphertext indicating whether an order was found.

2) If a matching order was not found, then the encrypted order is appended to OrderBook.

3) If an order was found, the operator decrypts the index j of the best matched encrypted order using TFHE.Dec. The order in the OrderBook is still not decrypted. It then computes (using TFHE.Eval) min—the minimum value between the two encrypted values of the number of shares in the new order and the matching order that was found in the OrderBook. It then runs TFHE.Dec to decrypt the op of both orders (i.e., Buy/Sell), the computed ciphertext min—the number of shares, and the price of the order that was found in the OrderBook. It can execute the two matching orders.

4) The operator then computes (using TFHE.Eval) an encrypted value—whether min=num′, i.e., whether the order from the order book is completely resolved. It decrypts this bit using TFHE.Dec. If indeed min=num′, then it removes the j-th encrypted order from OrderBook, and re-runs the ResolveOrder function with o_new=(op, symb, num-min, price) where all attributes are encrypted.

5) The operator also computes an encrypted value (using TFHE.Eval), whether min=num, i.e., whether the new submitted order is completely satisfied. It decrypts this bit using TFHE.Dec. If this is the case, then the new order is completely resolved, and we finish the command resolveOrder.

Referring to FIG. 6, in an exemplary embodiment, a dark pool with multiple operators may be implemented in accordance with Functionality 5.1 as defined below. This embodiment may be suitable when the participants in the dark pool do not trust any operator, and so each participant secret shares its order and sends it directly to each one of the operators:

Functionality 5.1: The Reactive Functionality F_{DPPDP}

Participating parties: The participating parties are the participants P₁, . . . , Pₙ, and the op-
erators [symbol] ₁, . . . , [symbol] ₘ. The functionality also interacts with the NBBO server and the public
exchange.
Secret state: Same as in Functionality 3.2.
Supported commands: The functionality supports the same commands as Functionality 3.2
while: (1) Output is being sent to opirators [symbol] ₁, . . . , [symbol] ₘ and not to participants; (2) Only
operators can issue commands InitOrderBook and ExecuteMatches. (3) Every participant Pᵢ can
issue the command ResolveOrder.

In an exemplary embodiment, Functionality 5.1 may be realized by using MPC. In exemplary embodiment, one objective is to minimize communication between the participants, and another objective is for the operators to execute the secure computation part. In this aspect, a possible approach is that each participant, when issuing an order o, will secret share the order among the different operators. The operators will then run a secure computation protocol for which their joint input defines the secret order.

Referring to FIG. 8, in an exemplary embodiment, a dark pool with no operator may be implemented in accordance with Functionality 6.1 as defined below. This embodiment may be suitable when the participants in the dark pool do not trust any operator, and so each participant will act in the role of an operator—i.e., they will hold the secret state of OrderBook using secret sharing, and when submitting an order, the order is being secret shared and sent directly to all other participants, while each participant receives one share. Then, each participant runs the secure protocol for realizing the order, in place of the operators that are not present for this embodiment:

Functionality 6.1: The Reactive Functionality F_{mpc}

Participating parties: The participating parties are the participants Pₗ, . . . , Pₙ. There are
no operators. The functionality also interacts with the NBBO server and the public exchange.
Secret state: Same as in Functionality 3.2.
Supported commands: The functionality supports the same commands as Functionality 3.2
with the following modifications: (1) All notifications and output are performed to all partici-
pants Pₗ, . . . , Pₘ: (2) Participants can issue commands InitOrderBook and ExecuteMatches. (3)
Every participant Pᵢ can issue the command ResolveOrder;

In an exemplary embodiment, Functionality 6.1 is a direct application of an MPC protocol between the participants. In particular, in place of an operator that would otherwise serve as the external trusted party for finding matching orders, the code that this operator performs is described in Functionality 6.1.

Using MPC techniques, the operator may be replaced with a secure protocol between the participants without exposing the secret orders. However, the number of orders being executed is revealed, and the identities of the participants that issue an order at a particular time are also revealed.

Accordingly, with this technology, an optimized process for implementing privacy protections in private forums for trading financial products is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for preserving privacy in a trading environment, the method being implemented by a processor on a computing device, the method comprising:
receiving, from each of a first plurality of users, a respective buy order to buy a respective security, each respective buy order including encrypted buy order information;
receiving, from each of a second plurality of users, a respective sell order to sell a respective security, each respective sell order including encrypted sell order information;
determining, by the processor, whether at least one received buy order matches with at least one received sell order; and
when a determination is made that the at least one received buy order matches the at least one received sell order, executing a transaction based on the matching at least one received buy order and the matching at least one received sell order,
wherein the determining comprises comparing the encrypted buy order information of each received buy order with the encrypted sell order information of each received sell order without decrypting the encrypted buy order information of each received buy order and without decrypting the encrypted sell order information of each received sell order, and
wherein the executing the transaction comprises decrypting the encrypted buy order information of the matching at least one received buy order, decrypting the encrypted sell order information of the matching at least one received sell order, and disclosing the decrypted information to an operator of the computing device.

2. The method of claim 1, wherein for each respective buy order, the encrypted buy information includes an encrypted security identifier, an encrypted number of shares, and an encrypted maximum offer price.

3. The method of claim 1, wherein for each respective sell order, the encrypted sell order information includes an encrypted security identifier, an encrypted number of shares, and an encrypted minimum sell price.

4. The method of claim 1, wherein the determining comprises using a secure Multi-Party Computation (MPC) cryptographic protocol to implement a matching algorithm, and wherein each respective buy order and each respective sell order is transmitted in an encrypted way based on an instruction that relates to the MPC cryptographic protocol.

5. The method of claim 1, wherein the determining comprises:
using a fully homomorphic encryption (FHE) scheme to implement a matching algorithm;
transmitting a result of the matching algorithm to each of the first plurality of users and to each of the second plurality of users; and
receiving, from each of the first plurality of users and the second plurality of users in response to the transmitting, decryption information that is usable for determining whether a match exists, and
wherein each respective buy order and each respective sell order is transmitted in an encrypted way based on an instruction that relates to the FHE scheme.

6. A method for preserving privacy in a trading environment, the method being implemented by a processor on a computing device, the method comprising:
receiving, from each of a plurality of users, a respective order that relates to a respective security, each respective order including encrypted order information;
submitting a first order that relates to a first security, the first order including first order information;
determining, by the processor, whether at least one received order matches with the submitted first order; and
when a determination is made that the at least one received order matches the submitted first order, executing a transaction based on the matching at least one received order and the submitted first order,
wherein the determining comprises comparing the encrypted buy order information of each received buy order with the encrypted sell order information of each received sell order without decrypting the encrypted buy order information of each received buy order and without decrypting the encrypted sell order information of each received sell order, and
wherein the executing the transaction comprises decrypting the encrypted buy order information of the matching at least one received buy order, decrypting the encrypted sell order information of the matching at least one received sell order, and disclosing the decrypted information to an operator of the computing device.

7. The method of claim 6, wherein for each received order, the encrypted order information includes an encrypted security identifier, an encrypted buy/sell indicator that indicates one of a buy order and a sell order, an encrypted number of shares, and an encrypted order price.

8. The method of claim 7, wherein the first order information includes a first security identifier, a first buy/sell indicator that indicates one of a buy order and a sell order, a first number of shares, and a first order price, and
wherein when the first buy/sell indicator indicates a buy order, the determining comprises determining whether the encrypted order information of at least one received order includes an encrypted security identifier that matches the first security identifier, an encrypted buy/sell indicator that indicates a sell order, and an encrypted order price that is less than or equal to the first order price, and
wherein when the first buy/sell indicator indicates a sell order, the determining comprises determining whether the encrypted order information of at least one received order includes an encrypted security identifier that matches the first security identifier, an encrypted buy/sell indicator that indicates a buy order, and an encrypted order price that is greater than or equal to the first order price.

9. The method of claim 6, wherein the determining comprises using a secure Multi-Party Computation (MPC) cryptographic protocol to implement a matching algorithm, and wherein each respective buy order and each respective sell order is transmitted in an encrypted way based on an instruction that relates to the MPC cryptographic protocol.

10. The method of claim 6, wherein the determining comprises:
using a fully homomorphic encryption (FHE) scheme to implement a matching algorithm;
transmitting a result of the matching algorithm to each of the first plurality of users and to each of the second plurality of users; and
receiving, from each of the first plurality of users and the second plurality of users in response to the transmitting, decryption information that is usable for determining whether a match exists, and
wherein each respective buy order and each respective sell order is transmitted in an encrypted way based on an instruction that relates to the FHE scheme.

11. A system for preserving privacy in a trading environment, the system comprising:
a processor;
a memory; and
a communication interface coupled to each of the processor and the memory,
wherein the processor is configured to:
receive, via the communication interface, from each of a first plurality of users, a respective buy order to buy a respective security, each respective buy order including encrypted buy order information;
receive, via the communication interface, from each of a second plurality of users, a respective sell order to sell a respective security, each respective sell order including encrypted sell order information;
determine whether at least one received buy order matches with at least one received sell order; and
when a determination is made that the at least one received buy order matches the at least one received sell order, execute a transaction based on the matching at least one received buy order and the matching at least one received sell order,
wherein the processor is further configured to make the determination by comparing the encrypted buy order information of each received buy order with the encrypted sell order information of each received sell order without decrypting the encrypted buy order information of each received buy order and without decrypting the encrypted sell order information of each received sell order, and
wherein when the transaction is executed, the processor is further configured to decrypt the encrypted buy order information of the matching at least one received buy order, decrypt the encrypted sell order information of the matching at least one received sell order, and disclose the decrypted information to an operator of the system.

12. The system of claim 11, wherein for each respective buy order, the encrypted buy information includes an encrypted security identifier, an encrypted number of shares, and an encrypted maximum offer price.

13. The system of claim 11, wherein for each respective sell order, the encrypted sell offer information includes an encrypted security identifier, an encrypted number of shares, and an encrypted minimum sell price.

14. The system of claim 11, wherein the processor is further configured to make the determination by using a secure Multi-Party Computation (MPC) cryptographic protocol to implement a matching algorithm, and wherein each respective buy order and each respective sell order is transmitted in an encrypted way based on an instruction that relates to the MPC cryptographic protocol.

15. The system of claim 11, wherein the processor is further configured to make the determination by:
using a fully homomorphic encryption (FHE) scheme to implement a matching algorithm,
transmitting a result of the matching algorithm to each of the first plurality of users and to each of the second plurality of users; and
receiving, from each of the first plurality of users and the second plurality of users in response to the transmitting, decryption information that is usable for determining whether a match exists, and
and wherein each respective buy order and each respective sell order is transmitted in an encrypted way based on an instruction that relates to the FHE scheme.
